(19) United States
(12) Patent Application Publication
(10) Pub. No.: US 2018/0204216 A1
(43) Pub. Date: Jul. 19, 2018

(54) TRANSACTION SETTLEMENT SYSTEMS AND METHODS

(71) Applicant: Baton Systems, Inc., Fremont, CA (US)

(72) Inventors: Arjun Jayaram, Fremont, CA (US); Mohammad Taha Abidi, San Ramon, CA (US); Daniel Craig Mandell, San Anselmo, CA (US); Nikhil Nayab, Princeton, NJ (US)

(21) Appl. No.: 15/923,961

(22) Filed: Mar. 16, 2018

Related U.S. Application Data
(63) Continuation-in-part of application No. 15/701,313, filed on Sep. 11, 2017.
(60) Provisional application No. 62/472,891, filed on Mar. 17, 2017.
(60) Provisional application No. 62/393,399, filed on Sep. 12, 2016.
(60) Provisional application No. 62/393,395, filed on Sep. 12, 2016.

(51) Int. Cl. G06Q 20/40; G06Q 20/02

(52) U.S. Cl. CPC G06Q 20/405; G06Q 20/027

(57) ABSTRACT

Example transaction settlement systems and methods are described. In one implementation, a financial management system identifies first operating rules associated with a first participant to a transaction. The financial management system also identifies second operating rules associated with a second participant to the transaction. A workflow is created, based on the first operating rules and the second operating rules, that defines a sequence of activities associated with the transaction. The financial management system executes the workflow to implement the transaction.

### RELATED APPLICATIONS

This application is a continuation-in-part of, and claims the priority benefit of, U.S. patent application Ser. No. 15/701,313, entitled “Financial Management Systems and Methods,” filed on Sep. 11, 2017, the disclosure of which is incorporated by reference herein in its entirety. That application claims the priority benefit of U.S. Provisional Application Ser. No. 62/393,395, entitled “Tamper Resistance,” filed Sep. 12, 2016, the disclosure of which is incorporated by reference herein in its entirety. That application also claims the priority benefit of U.S. Provisional Application Ser. No. 62,393,399, entitled “Constructs of Multiparty Reconciliation,” filed Sep. 12, 2016, the disclosure of which is incorporated by reference herein in its entirety.

This application also claims the priority benefit of U.S. Provisional Application Ser. No. 62/472,891, entitled “Structure, Operating Rules and Settlement Finality for Ubixi Transactions Through the Use of Settlement Accounts,” filed on Mar. 17, 2017, the disclosure of which is hereby incorporated by reference herein in its entirety.

### TECHNICAL FIELD

The present disclosure relates to financial systems and, more particularly, to systems and methods associated with the settlement of financial transactions.

### BACKGROUND

Various financial systems are used to transfer assets between different organizations, such as financial institutions. For example, in existing systems, each financial institution maintains a ledger to keep track of accounts at the financial institution and transactions associated with those accounts. Financial institutions generally cannot access the ledger of another financial institution. Thus, a particular financial institution can only see part of a financial transaction (i.e., the part of the transaction associated with that financial institution's accounts). When executing critical asset transfers, it is important that all parties to the transfer can see the details of the transfer. Further, it is important that all data is authenticated to maintain the integrity of the financial systems.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram illustrating an environment within which an example embodiment may be implemented.

FIG. 2 is a block diagram illustrating an embodiment of a financial management system configured to communicate with multiple other systems.

FIG. 3 illustrates an embodiment of an example asset transfer between two financial institutions.

FIG. 4 illustrates an embodiment of a method for transferring assets between two financial institutions.

FIG. 5 illustrates an embodiment of a method for authenticating a client and validating a transaction.

FIG. 6 is a block diagram illustrating an embodiment of a financial management system interacting with an API server and an audit server.

FIG. 7 illustrates an embodiment of an example bilateral asset transfer between two principals.

FIG. 8 illustrates an embodiment of an environment having a financial management system database and multiple potential parties to a transaction.

FIG. 9 illustrates an embodiment of various levels of data protection provided by the systems and methods described herein.

FIG. 10 illustrates an example state diagram showing various states that a transaction may pass through.

FIG. 11 is a block diagram illustrating an embodiment of a financial management system interacting with a cryptographic service and multiple client nodes.

FIG. 12 is a block diagram illustrating an example computing device.

### DETAILED DESCRIPTION

It will be readily understood that the components of the present systems and methods, as generally described and illustrated in the figures herein, could be arranged and designed in a wide variety of different configurations. The following detailed description of the embodiments of the transaction settlement systems and methods is not intended to limit the scope of the invention, as claimed, but is merely representative of certain examples of presently contemplated embodiments in accordance with the invention.

Existing financial institutions typically maintain account information and asset transfer details in a ledger at the financial institution. The ledgers at different financial institutions do not communicate with one another and often use different data storage formats or protocols. Thus, each financial institution can only access its own ledger and cannot see data in another financial institution's ledger, even if the two financial institutions implemented a common asset transfer.

The systems and methods described herein enable institutions to move assets on demand by enabling authorized users to execute complex workflows. Additionally, the described systems and methods support the use and management of various operating rules associated with different types of transactions and different parties in different jurisdictions.

As used herein, a workflow describes, for example, the sequence of activities associated with a particular transaction, such as an asset transfer. In particular, the systems and methods provide a clearing and settlement gateway between, for example, multiple financial institutions. When a workflow is created, the particular series of activities defined by the workflow may be based on one or more operating rules associated with the parties to the transaction, as discussed herein. Particular operating rules may limit the exposure of a financial institution, limit transaction amounts, define required settlement times, the number of signatures required for particular types of transactions, and the like. Thus, specific workflows may be unique to the specific parties to the transaction due to their differing operating rules. In some embodiments, operating rules may be associated with a particular party or participant to a transaction, associated with a particular type or category of parties or participants to a transaction, associated with a particular jurisdiction (e.g., state, county, country, and the like), associated with a particular regulatory agency or organization, and the like. In some situations, multiple operating rules are associated with the same party or participant, such as the party's own entity operating rules as well as jurisdictional operating rules for the jurisdiction in which the party is located.

When a workflow is executed, the system generates and issues clearing and settlement messages to facilitate the movement of assets. A shared permissioned ledger (discussed herein) keeps track of the asset movement and provides visibility to the principals and observers in substantially real time. The integrity of these systems and methods is important because the systems are dealing with core payments that are a critical part of banking operations. Additionally, many asset movements are final and irreversible. Therefore, the authenticity of the request and the accuracy of the instructions are crucial. Further, reconciliation of transactions between multiple parties are important to the management of financial data.

As discussed herein, payments between parties can be performed using multiple asset types, including currencies, treasuries, securities (e.g., notes, bonds, bills, and equities), and the like. Payments can be made for different reasons, such as margin movements, collateral pledging, swaps, delivery, fees, liquidation proceeds, and the like. As discussed herein, each payment may be associated with one or more metadata.

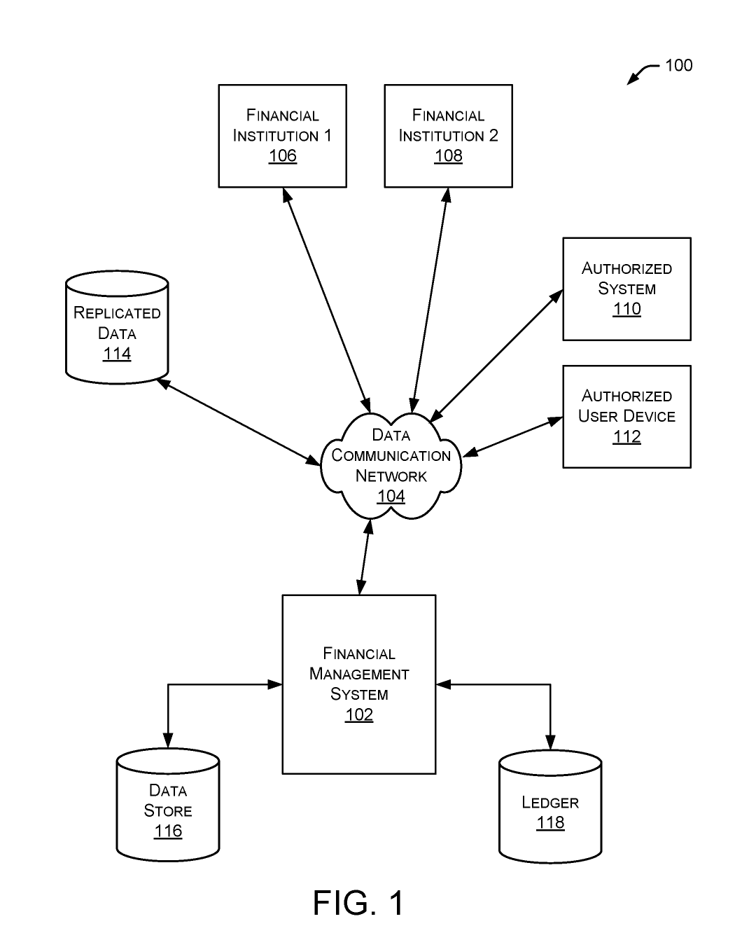

FIG. 1 is a block diagram illustrating an environment 100 within which an example embodiment may be implemented. A financial management system 102 is coupled to a data communication network 104 and communicates with one or more other systems, such as financial institutions 106, 108, an authorized system 110, an authorized user device 112, and a replicated data store 114. As discussed in greater detail herein, financial management system 102 performs a variety of operations, such as facilitating the transfer of assets between multiple financial institutions or other entities, systems, or devices. Although many asset transfers include the use of a central bank to clear and settle the funds, the central bank is not shown in FIG. 1. A central bank provides financial services for a country's government and commercial banking system. In the United States, the central bank is the Federal Reserve Bank. In some implementations, financial management system 102 provides an on-demand gateway integrated into the heterogeneous core ledgers of financial institutions (e.g., banks) to view funds and clear and settle all asset classes. Additionally, financial management system 102 may efficiently settle funds using existing services such as FedWire.

In some embodiments, data communication network 104 includes any type of network, such as a local area network, a wide area network, the Internet, a cellular communication network, or any combination of two or more communication networks. The described systems and methods can use any communication protocol supported by a financial institution's ledger and other systems. For example, the communication protocol may include SWIFT MT (Society for Worldwide Interbank Financial Telecommunication Message Type) messages (such as MT 2XX, 5XX, 9XX), ISO 20022 (a standard for electronic data interchange between financial institutions), and proprietary application interfaces exposed by particular financial institutions. Financial institutions 106, 108 include banks, exchanges, hedge funds, and any other type of financial entity or system. In some embodiments, financial management system 102 interacts with financial institutions 106, 108 using existing APIs and other protocols already being used by financial institutions 106, 108, thereby allowing financial management system 102 to interact with existing financial institutions without significant modification to the financial institution's systems. Authorized system 110 and authorized user device 112 include any type of system, device, or component that is authorized to communicate with financial management system 102. Replicated data store 114 stores any type of data accessible by any number of systems and devices, such as the systems and devices described herein. In some embodiments, replicated data store 114 stores immutable and auditable forms of transaction data between financial institutions. The immutable data cannot be deleted or modified. In particular implementations, replicated data store 114 is an append only data store which keeps track of all intermediate states of the transactions. Additional metadata may be stored along with the transaction data for referencing information available in external systems. In specific embodiments, replicated data store 114 may be contained within a financial institution or other system.

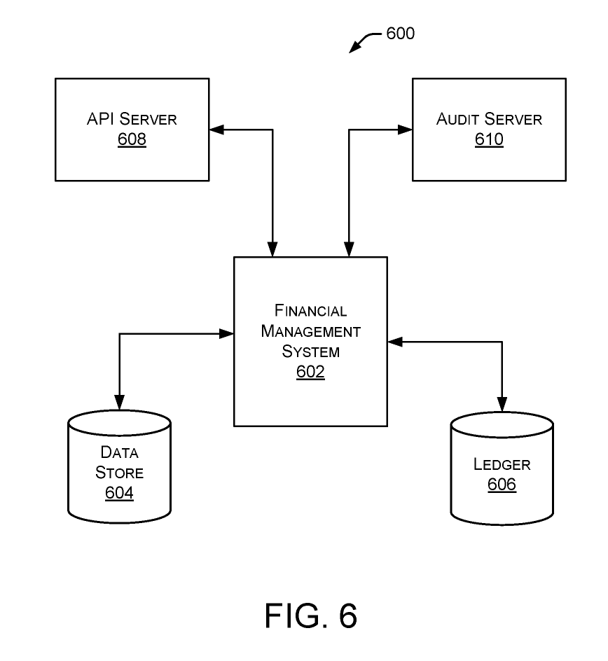

As shown in FIG. 1, financial management system 102 is also coupled to a data store 116 and a ledger 118. In some embodiments, data store 116 is configured to store data used during the operation of financial management system 102. Ledger 118 stores data associated with multiple financial transactions, such as asset transfers between two financial institutions. As discussed herein, ledger 118 is constructed in a manner that tracks when a transaction was initiated and who initiated the transaction. Thus, ledger 118 can track all transactions and generate an audit trail, as discussed herein. Ledger 118 may also be referred to as a “shared ledger” or “shared permissioned ledger.” Using an audit server of the type described with respect to FIG. 6, financial management system 102 can support audit trails from both the financial management system and external systems and devices. In some embodiments, each transaction entry in ledger 118 records a client identifier, a hash of the transaction, an initiator of the transaction, and a time of the transaction. This data is useful in auditing the transaction data.

In some embodiments, ledger 118 is modeled after double-entry accounting systems where each transaction has two entries (i.e., one entry for each of the principals to the transaction). The entries in ledger 118 include data related to the principal parties to the transaction, a transaction date, a transaction amount, a transaction state, any relevant workflow reference, a transaction ID, and any additional metadata to associate the transactions with one or more external systems. The entries in ledger 118 also include cryptographic hashes to provide tamper resistance and auditability. Users for each of the principals to the transaction only have access to their own entries (i.e., the transactions to which the principal was a party). Access to the entries in ledger 118 can be further restricted or controlled based on a user's role or a party's role, where certain data is only available to certain roles.

In some embodiments, ledger 118 is a shared ledger that can be accessed by multiple financial institutions and other systems and devices. In particular implementations, both parties to a specific transaction can access all details related to that transaction stored in ledger 118. All details related to the transaction include, for example, the parties involved in the transaction, the type of transaction, the date and time of the transaction, the amount of the transaction, and other data associated with the transaction. Additionally, ledger 118 restricts permission to access specific transaction details based on relevant trades associated with a particular party. For example, if a specific party (such as a financial institution or other entity) requests access to data in ledger 118, that party can only access (or view) data associated with transactions to which the party was involved. Thus, a specific party cannot see data associated with transactions that are associated with other parties and do not include the specific party.

The shared permission aspects of ledger 118 provides for a subset of the ledger data to be replicated at various client nodes and other systems. The financial management systems and methods discussed herein allow selective replication of data. Thus, principals, financial institutions, and other entities do not have to hold data for transactions to which they were not a party.

It will be appreciated that the embodiment of FIG. 1 is given by way of example only. Other embodiments may include fewer or additional components without departing from the scope of the disclosure. Additionally, illustrated components may be combined or included within other components without limitation. In some embodiments, financial management system 102 may also be referred to as a “financial management platform,” “financial transaction system,” “financial transaction platform,” “asset management system,” or “asset management platform.”

In some embodiments, financial management system 102 interacts with authorized systems and authorized users. The authorized set of systems and users often reside outside the jurisdiction of financial management system 102. Typically, interactions with these systems and users are performed via secured channels. To ensure the integrity of financial management system 102, various constructs are used to provide system/platform integrity as well as data integrity.

In some embodiments, system/platform integrity is provided by using authorized (e.g., whitelisted) machines and devices, and verifying the identity of each machine using security certificates, cryptographic keys, and the like. In certain implementations, particular API access points are determined to ensure that a specific communication originates from a known enterprise or system. Additionally, the systems and methods described herein maintain a set of authorized users and roles, which may include actual users, systems, devices, or applications that are authorized to interact with financial management system 102. System/platform integrity is also provided through the use of secure channels to communicate between financial management system 102 and external systems. In some embodiments, communication between financial management system 102 and external systems is performed using highly secure TLS (Transport Layer Security) with well-established handshakes between financial management system 102 and the external systems. Particular implementations may use dedicated virtual private clouds (VPCs) for communication between financial management system 102 and any external systems. Dedicated VPCs offer clients the ability to set up their own security and rules for accessing financial management system 102. In some situations, an external system or user may use the DirectConnect network service for better service-level agreements and security.

In some embodiments financial management system 102 allows each client to configure and leverage their own authentication systems. This allows clients to set their custom policies on user identity verification (including 2FA (two factor authentication)) and account verification. An authentication layer in file management system 102 delegates requests to client systems and allows the financial management system to communicate with multiple client authentication mechanisms.

Financial management system 102 also supports role-based access control of workflows and the actions associated with workflows. Example workflows may include Payment vs Payment (PVP) and Delivery vs Payment (DVP) workflows. In some embodiments, users can customize a workflow to add their own custom steps to integrate with external systems that can trigger a change in transaction state or associate them with manual steps. Additionally, system developers can develop custom workflows to support new business processes. In particular implementations, some of the actions performed by a workflow can be manual approvals, a SWIFT message request/response, scheduled or time-based actions, and the like. In some embodiments, roles can be assigned to particular users and access control lists can be applied to roles. An access control list controls access to actions and operations on entities within a network. This approach provides a hierarchical way of assigning privileges to users. A set of roles also includes roles related to replication of data, which allows financial management system 102 to identify what data can be replicated and who is the authorized user to be receiving the data at an external system.

In some embodiments, financial management system 102 detects and records all client metadata, which creates an audit trail for the client metadata. Additionally, one or more rules identify anomalies which may trigger a manual intervention by a user or principal to resolve the issue. Example anomalies include system request patterns that are not expected, such as a high number of failed login attempts, password resets, invalid certificates, volume of requests, excessive timeouts, http errors, and the like. Anomalies may also include data request patterns that are not expected, such as first time use of an account number, significantly larger than normal amount of payments being requested, attempts to move funds from an account just added, and the like. When an anomaly is triggered, financial management system 102 is capable of taking a set of actions. The set of actions may initially be limited to pausing the action, notifying the principals of the anomaly, and only resuming activity upon approval from a principal.

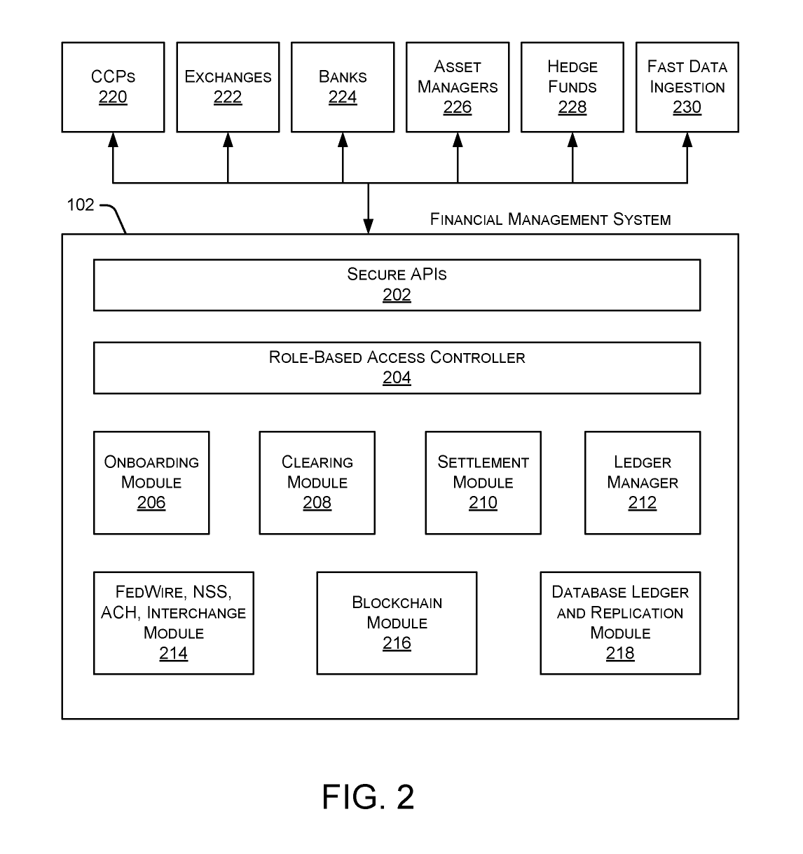

FIG. 2 is a block diagram illustrating an embodiment of financial management system 102 configured to communicate with multiple other systems. As shown in FIG. 2, financial management system 102 may be configured to communicate with one or more CCPs (Central Counterpart Clearing Houses) 220, one or more exchanges 222, one or more banks 224, one or more asset managers 226, one or more hedge funds 228, and one or more fast data ingestion systems (or “pipes”) 230. CCPs 220 are organizations that facilitate trading in various financial markets. Exchanges 222 are marketplaces in which securities, commodities, derivatives, and other financial instruments are traded. Banks 224 include any type of bank, credit union, savings and loan, or other financial institution. Asset managers 226 include asset management organizations, asset management systems, and the like. In addition to hedge funds 228, financial management system 102 may also be configured to communicate with other types of funds, such as mutual funds. Financial management system 102 may communicate with CCPs 220, exchanges 222, banks 224, asset managers 226, and hedge funds 228 using any type of communication network and any communication protocol. Fast data ingestion systems 230 include at least one data ingestion platform that consumes trades in real-time along with associated events and related metadata. The platform is a high throughput pipe which provides an ability to ingest trade data in multiple formats. The trade data are normalized to a canonical format, which is used by downstream engines like matching, netting, real-time counts, and liquidity projections and optimizers. The platform also provides access to information in real-time to different parties of the trade.

Financial management system 102 includes secure APIs 202 that are used by partners to securely communicate with financial management system 102. In some embodiments, the APIs are stateless to allow for automatic scaling and load balancing. Role-based access controller 204 provide access to modules, data and activities based on the roles of an individual user or participant interacting with financial management system 102. In some embodiments, users belong to roles that are given permissions to perform certain actions. An API request may be checked against the role to determine whether the user has proper permissions to perform an action. An onboarding module 206 includes all of the metadata associated with a particular financial institution, such as bank account information, user information, roles, permissions, clearing groups, assets, and supported workflows. A clearing module 208 includes, for example, a service that provides the functionality to transfer assets between accounts within a financial institution. A settlement module 210 monitors and manages the settlement of funds or other types of assets associated with one or more transactions handled by financial management system 102.

Financial management system 102 also includes a ledger manager 212 that manages a ledger (e.g., ledger 118 in FIG. 1) as discussed herein. A FedWire, NSS (National Settlement Service), ACH (Automated Clearing House), Interchange module 214 provides a service used to interact with standard protocols like FedWire and ACH for the settlement of funds. A blockchain module 216 provides interoperability with blockchains for settlement of assets on a blockchain. A database ledger and replication module 218 provides a service that exposes constructs of a ledger to the financial management system. Database ledger and replication module 218 provides functionality to store immutable transaction states with the ability to audit them. The transaction data can also be replicated to authorized nodes for which they are either a principal or an observer. Although particular components are shown in FIG. 2, alternate embodiments of financial management system 102 may contain additional components not shown in FIG. 2, or may not contain some components shown in FIG. 2. Although not illustrated in FIG. 2, financial management system 102 may contain one or more processors, one or more memory devices, and other components such as those discussed herein with respect to FIG. 13.

In the example of FIG. 2, various modules, components, and systems are shown as being part of financial management system 102. For example, financial management system 102 may be implemented, at least in part, as a cloud-based system. In other examples, financial management system 102 is implemented, at least on part, in one or more data centers. In some embodiments, some of these modules, components, and systems may be stored in (and/or executed by) multiple different systems. For example, certain modules, components, and systems may be stored in (and/or executed by) one or more financial institutions.

As mentioned above, system/platform integrity is important to the secure operation of financial management system 102. This integrity is maintained by ensuring that all actions are initiated by authorized users or systems. Additionally, once an action is initiated and the associated data is created, an audit trail of any changes made and other information related to the action is recorded for future reference.

In particular embodiments, financial management system 102 includes (or interacts with) a roles database and an authentication layer. The roles database stores various roles of the type discussed herein.

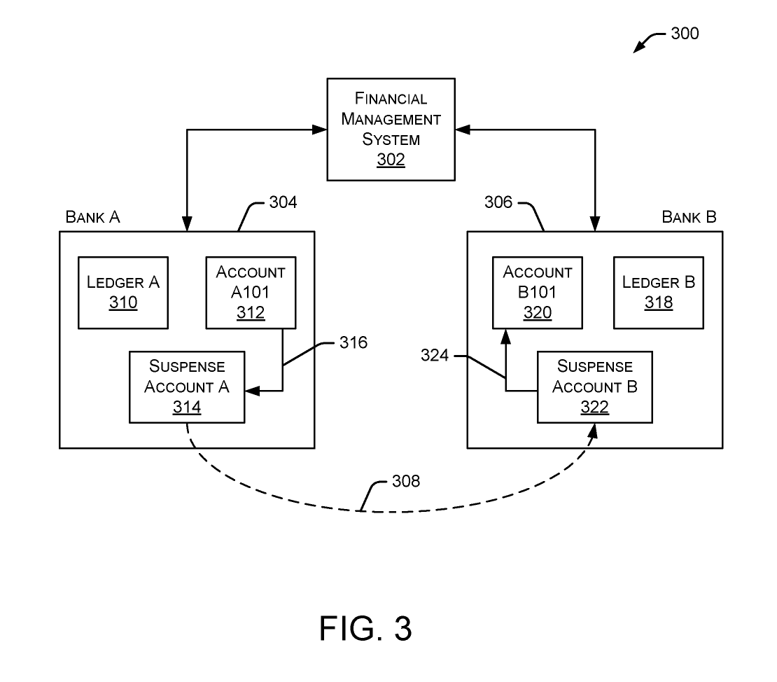

FIG. 3 illustrates an embodiment 300 of an example asset transfer between two financial institutions. In the example of FIG. 3, financial management system 302 is in communication with a first bank 304 and a second bank 306. In this example, funds are being transferred from an account at bank 304 to an account at bank 306, as indicated by broken line 308. Bank 304 maintains a ledger 310 that identifies all transactions and data associated with transactions that involve bank 304. Similarly, bank 306 maintains a ledger 318 that identifies all transactions and data associated with transactions that involve bank 306. In some embodiments, ledgers 310 and 318 (or the data associated with ledgers 310 and 318) reside in financial management system 302 as a shared, permissioned ledger, such as ledger 118 discussed above with respect to FIG. 1.

In the example of FIG. 3, funds are being transferred out of an account 312 at bank 304. To facilitate the transfer of funds out of account 312, the funds being transferred are moved 316 from account 312 to a first suspense account 314 at bank 304. Each suspense account discussed herein is a “For Benefit Of” (FBO) account and is operated by the financial management system for the members of the network (i.e., all parties and principals). The financial management system may facilitate the transfer of assets into and out of the suspense accounts. However, the financial management system does not take ownership of the assets in the suspense accounts. The credits and debits associated with each suspense account are issued by the financial management system and the ledger (e.g., ledger 118 in FIG. 1) is used to track ownership of the funds in the suspense accounts. Each suspense account has associated governance rules that define how the suspense account operates. At bank 306, the transferred funds are received by a second suspense account 322. The funds are moved 324 from second suspense account 322 to an account 320 at bank 306.

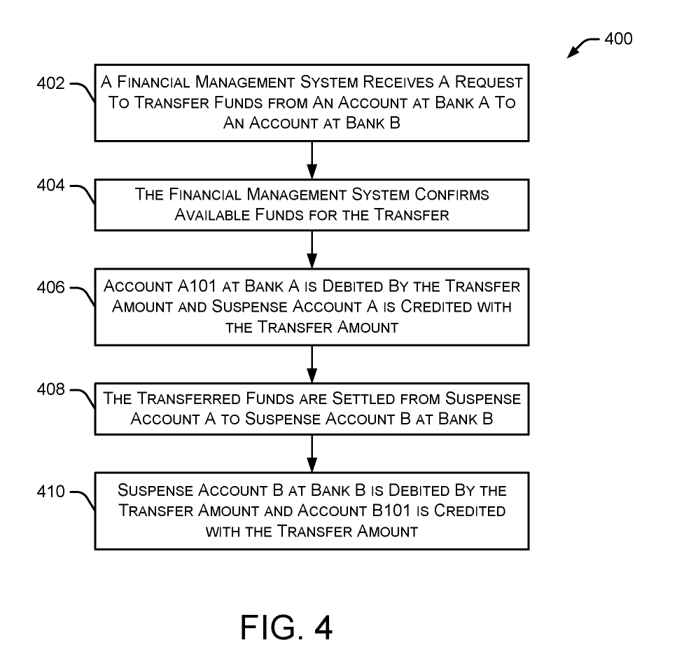

As discussed herein, financial management system 302 facilitates the transfer of funds between bank 304 and 306. Additional details regarding the manner in which the funds are transferred are provided below with respect to FIG. 4. Although only one account and one suspense account is shown for each bank in FIG. 3, particular embodiments of bank 304 and 306 may contain any number of accounts and suspense accounts. Additionally, bank 304 and 306 may contain any number of ledgers and other systems. In some embodiments, each suspense account 314, 322 is established as part of the financial institution “onboarding” process with the financial management system. For example, the financial management system administrators may work with financial institutions to establish suspense accounts that can interact with the financial management system as described herein.

In some embodiments, one or more components discussed herein are contained in a traditional infrastructure of a bank or other financial institution. For example, an HSM (Hardware Security Module) in a bank may execute software or contain hardware components that interact with a financial management system to facilitate the various methods and systems discussed herein. In some embodiments, the HSM provides security signatures and other authentication mechanisms to authenticate participants of a transaction.

FIG. 4 illustrates an embodiment of a method 400 for transferring assets (e.g., funds) between two financial institutions. Initially, a financial management system receives 402 a request to transfer funds from an account at Bank A to an account at Bank B. The request may be received by Bank A, Bank B, or another financial institution, system, device, and the like. Using the example of FIG. 3, financial management system 302 receives a request to transfer funds from account 312 at bank 304 to account 320 at bank 306.

Method 400 continues as the financial management system confirms 404 available funds for the transfer. For example, financial management system 302 in FIG. 3 may confirm that account 312 at bank 304 contains sufficient funds to satisfy the amount of funds defined in the received transfer request. In some embodiments, if available funds are confirmed at 404, the financial management system creates suspense account A at Bank A and creates suspense account B at Bank B. In particular implementations, suspense account A and suspense account B are temporary suspense accounts created for a particular transfer of funds. In other implementations, suspense account A and suspense account B are temporary suspense accounts but are used for a period of time (or for a number of transactions) to support transfers between bank A and bank B.

If available funds are confirmed at 404, then account A101 at Bank A is debited 406 by the transfer amount and suspense account A (at Bank A) is credited with the transfer amount. Using the example of FIG. 3, financial management system 302 debits the transfer amount from account 312 and credits that transfer amount to suspense account 314. In some embodiments, ownership of the transferred assets changes as soon as the transfer amount is credited to suspense account 314.

The transferred funds are then settled 408 from suspense account A (at Bank A) to suspense account B (at Bank B). For example, financial management system 302 in FIG. 3 may settle funds from suspense account 314 in bank 304 to suspense account 322 in bank 306. The settlement of funds between two suspense accounts is determined by the counterparty rules set up between the two financial institutions involved in the transfer of funds. For example, a counterparty may choose to settle at the top of the hour or at a certain threshold to manage risk exposure. The settlement process may be determined by the asset type, the financial institution pair, and/or the type of transaction. In some embodiments, transactions can be configured to settle in gross or net. For gross transaction settlement of a PVP workflow, the settlement occurs instantaneously over existing protocols supported by financial institutions, such as FedWire, NSS, and the like. Netted transactions may also settle over existing protocols based on counterparty and netting rules. In some embodiments, the funds are settled after each funds transfer. In other embodiments, the funds are settled periodically, such as once an hour or once a day. Thus, rather than settling the two suspense accounts after each funds transfer between two financial institutions, the suspense accounts are settled after multiple transfers that occur over a period of time. Alternatively, some embodiments settle the two suspense accounts when the amount due to one financial institution exceeds a threshold value.

Method 400 continues as suspense account B (at Bank B) is debited 410 by the transfer amount and account B101 at Bank B is credited with the transfer amount. For example, financial management system 302 in FIG. 3 may debit suspense account 322 and credit account 320. After finishing step 410, the funds transfer from account 312 at bank 304 to account 320 at bank 306 is complete.

In some embodiments, the financial management system facilitates (or initiates) the debit, credit, and settlement activities (as discussed with respect to FIG. 4) by sending appropriate instructions to Bank A and/or Bank B. The appropriate bank then performs the instructions to implement at least a portion of method 400. The example of method 400 can be performed with any type of asset. In some embodiments, the asset transfer is a transfer of funds using one or more traditional currencies, such as U.S. Dollars (USD) or Great British Pounds (GBP).

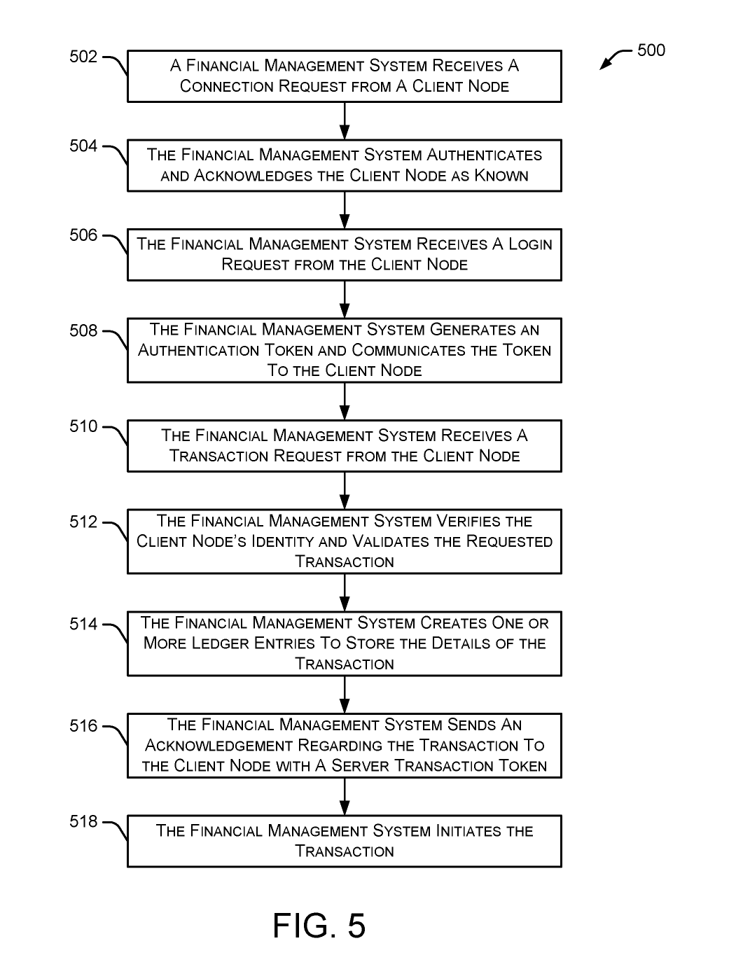

FIG. 5 illustrates an embodiment of a method 500 for authenticating a client and validating a transaction. Initially, a financial management system receives 502 a connection request from a client node, such as a financial institution, an authorized system, an authorized user device, or other client types mentioned herein. The financial management system authenticates 504 and, if authenticated, acknowledges the client node as known. Method 500 continues as the financial management system receives 506 a login request from the client node. In response to the login request, the financial management system generates 508 an authentication token and communicates the authentication token to the client node. In some embodiments, the authentication token is used to determine the identity of the user for future requests, such as fund transfer requests. The identity is then further checked for permissions to the various services or actions.

The financial management system further receives 510 a transaction request from the client node, such as a request to transfer assets between two financial institutions or other entities. In response to the received transaction request, the financial management system verifies 512 the client node's identity and validates the requested transaction. In some embodiments, the client node's identity is validated based on an authentication token, and then permissions are checked to determine if the user has permissions to perform a particular action or transaction. Transfers of assets also involve validating approval of an account by multiple roles to avoid compromising the network. If the client node's identity and requested transaction are verified, the financial management system creates 514 one or more ledger entries to store the details of the transaction. The ledger entries may be stored in a ledger such as ledger 118 discussed herein. The financial management system then sends 516 an acknowledgement regarding the transaction to the client node with a server transaction token. In some embodiments, the server transaction token is used at a future time by the client when conducting audits. Finally, the financial management system initiates 518 the transaction using, for example, the systems and methods discussed herein.

In some embodiments, various constructs are used to ensure data integrity. For example, cryptographic safeguards allow a transaction to span 1-n principals. The financial management system ensures that no other users (other than the principals who are parties to the transaction) can view data in transit. Additionally, no other user should have visibility into the data as it traverses the various channels. In some embodiments, there is a confirmation that a transaction was received completely and correctly. The financial management system also handles failure scenarios, such as loss of connectivity in the middle of the transaction. Any data transmitted to a system or device should be explicitly authorized such that each entry (e.g., ledger entry) can only be seen and read by the principals who were a party to the transaction. Additionally, principals can give permission to regulators and other individuals to view the data selectively.

Cryptographic safeguards are used to detect data tampering in the financial management system and any other systems or devices. Data written to the ledger and any replicated data may be protected by:

Stapling all the events associated with a single transaction.

Providing logical connections of each commit to those that came before it are made.

The logical connections are also immutable but principals can send messages for relinking. In this case, the current and all preceding links are maintained. For example, trade amendments are quite common. A trade amendment needs to be connected to the original trade. For forensic analysis, a bank may wish to identify all trades by a particular trader. Query characteristics will be graphs, time series, and RDBMS (Relational Database Management System).

In some embodiments, the financial management system monitors for data tampering. If the data store (central data store or replicated data store) is compromised in any way and the data is altered, the financial management system should be able to detect exactly what changed. Specifically, the financial management system should guarantee all participants on the network that their data has not been compromised or changed. Information associated with changes are made available via events such that the events can be sent to principals via messaging or available to view on, for example, a user interface. Regarding data forensics, the financial management system is able to determine that the previous value of an attribute was X, it is now Y and it was changed at time T, by a person A. If a system is hacked or compromised, there may be any number of changes to attribute X and all of those changes are captured by the financial management system, which makes the tampering evident.

In particular embodiments, the financial management system leverages the best security practices for SaaS (Software as a Service) platforms to provide cryptographic safeguards for ensuring integrity of the data. For ensuring data integrity, the handshake between the client and an API server (discussed with respect to FIG. 6) establish a mechanism which allows both the client and the server to verify the authenticity of transactions independently. Additionally, the handshake provides a mechanism for both the client and the server to agree on a state of the ledger. If a disagreement occurs, the ledger can be queried to determine the source of the conflict.

FIG. 6 is a block diagram illustrating an embodiment 600 of a financial management system 602 interacting with an API server 608 and an audit server 610. Financial management system 602 also interacts with a data store 604 and a ledger 606. In some embodiments, data store 604 and ledger 606 are similar to data store 116 and ledger 118 discussed herein with respect to FIG. 1. In particular implementations, API server 608 exposes functionality of financial management system 602, such as APIs that provide reports of transactions and APIs that allow for administration of nodes and counterparties. Audit server 610 periodically polls the ledger to check for data tampering of ledger entries. This check of the ledger is based on, for example, cryptographic hashes and are used to monitor data tampering as described herein.

In some embodiments, all interactions with financial management system 602 or the API server are secured with TLS. API server 608 and audit server 610 may communicate with financial management system 602 using any type of data communication link or data communication network, such as a local area network or the Internet. Although API server 608 and audit server 610 are shown in FIG. 6 as separate components, in some embodiments, API server 608 and/or audit server 610 may be incorporated into financial management system 602. In particular implementations, a single server may perform the functions of API server 608 and audit server 610.

In some embodiments, at startup, a client sends a few checksums it has sent and transaction IDs to API server 608, which can verify the checksums and transaction IDs, and take additional traffic from the client upon verification. In the case of a new client, mutually agreed upon seed data is used at startup. A client request may be accompanied by a client signature and, in some cases, a previous signature sent by the server. The server verifies the client request and the previous server signature to acknowledge the client request. The client persists the last server signature and a random set of server hashes for auditing. Both client and server signatures are saved with requests to help quickly audit correctness of the financial management system ledger. The block size of transactions contained in the request may be determined by the client. A client SDK (Software Development Kit) assists with the client server handshake and embedding on server side signatures. The SDK also persists a configurable amount of server signatures to help with restart and for random audits. Clients can also set appropriate block size for requests depending on their transaction rates. The embedding of previous server signatures in the current client block provides a way to chain requests and provide an easy mechanism to detect tampering. In addition to a client-side signature, the requests are encrypted using standard public key cryptography to provide additional defense against client impersonation. API server 608 logs all encrypted requests from the client. The encrypted requests are used, for example, during data forensics to resolve any disputes.

In particular implementations, a client may communicate a combination of a previous checksum, a current transaction, and a hash of the current transaction to the financial management system. Upon receipt of the information, the financial management system checks the previous checksum and computes a new checksum, and stores the client hash, the current transaction, and the current checksum in a storage device, such as data store 604. The checksum history and hash (discussed herein) protect the integrity of the data. Any modification to an existing row in the ledger cannot be made easily because it would be detected by mismatched checksums in the historical data, thereby making it difficult to alter the data.

The integrity of financial management system 602 is ensured by having server audits at regular intervals. Since financial management system 602 uses chained signatures per client at the financial management system, it ensures that an administrator of financial management system 602 cannot delete or update any entries without making the ledger tamper evident. In some embodiments, the auditing is done at two levels: a minimal level which the SDK enforces using a randomly selected set of server signatures to perform an audit check; and a more thorough audit check run at less frequent intervals to ensure that the data is correct.

In some implementations, financial management system 602 allows for the selective replication of data. This approach allows principals or banks to only hold data for transactions they were a party to, while avoiding storage of other data related to transactions in which they were not involved. Additionally, financial management system 602 does not require clients to maintain a copy of the data associated with their transactions. Clients can request the data to be replicated to them at any time. Clients can verify the authenticity of the data by using the replicated data and comparing the signature the client sent to the financial management system with the request.

In some embodiments, a notarial system is used to maintain auditability and forensics for the core systems. Rather than relying on a single notary hosted by the financial management system, particular embodiments allow the notarial system to be installed and executed on any system that interacts with the financial management system (e.g., financial institutions or clients that facilitate transactions initiated by the financial management system).

The systems and methods discussed herein support different asset classes. Each asset class may have a supporting set of metadata characteristics that are distinct. Additionally, the requests and data may be communicated through multiple “hops” between the originating system and the financial management system. During these hops, data may be augmented (e.g., adding trade positions, account details, and the like) or changed.

In certain types of transactions, such as cash transactions, the financial management system streamlines the workflow by supporting rich metadata accompanying each cash transfer. This rich metadata helps banks tie back cash movements to trades, accounts, and clients.

Payments for all money movement (and other asset movements) need to be reconciled between all principals and observers of a transaction. In many situations, reconciliation is also required for internal bookkeeping of an enterprise. Additionally, certain regulations require regular filing of certain types of events. The description below relates to examples where the different parties need to reconcile the payments (and related items) across the principals.

In some embodiments, payments flow between participants in a cleared market, such as between an end customer and a clearing house. The following example describes some of the problems with the reconciliation process in the cleared market space. For example, the clearing members may act as both brokers and dealers to execute trades on behalf of their clients or for themselves. A clearing member typically has several customers. There are different types of trade positions that a customer may initiate, such as equities, futures, currency hedging, derivatives, and the like. The clearing member will most likely execute a customer's trading activity at more than one exchange. A customer may clear through several clearing members.

In some embodiments, the exchange, through a clearing house, will initiate settlements for all trades that are executed on the exchange via the clearing members. The clearing house computes the net amounts that need to be either debited or credited from the accounts of the clearing members. These can be for “mark to market” variations on the trade positions. The market price is at a point in time as determined by the clearing house based on the data from several third party sources. The net amounts are then debited or credited from the accounts.

Following the debits and credits to the accounts, the clearing member needs to reconcile the single net payments to or from their accounts to the total positions across all clients. Some clients will be net positive and some net negative. They then proceed to send requests for payments to each of the clients. In this step, they may add some additional fees and other charges to the payment request. The client now needs to reconcile these to the actual positions. Since these are calls and may be delayed, the market positions may change and the market value of the trade position may also change. In effect, the following reconciliations need to happen between the participants.

Clearing House:

1—The net debits and credits from each account at the settlement bank. Sometimes in the case of a shortfall of funds, they need to request these payments from the settlement bank to authorize. In this situation, they send the request to the settlement bank and, when approved, the funds are debited. In these cases, regarding the request to withdraw, the subsequent approvals also need to be tied into the debit pulls and credit pushes to the accounts.

2—For each pull and push, the metadata associated with the gross positions of each entity are tied to the payments. This includes data tying to market data that is time bound (that is mark and market prices). Additionally, the fees and charges also need to be tied into the payments.

3—The collateral pledges and recall data also need to be tied to the payments. These payments have additional data attributes such as haircut amounts. The settlement of these assets outside of the same bank need to go through other settlement services such as DTC (Depository Trust Company).

Clearing Members:

1—The net debits from their account needs to be tied to each of its client's gross positions. Additionally, any other data such as charges and fees needs to be tied in to request a payment from the client or to tie in a credit push to their accounts.

2—The payments from the clients need to be tied to specific requests from the clearing members requesting payments. In some situations, the payments are not paid out in full when there is a discrepancy between the books and data.

3—Some trade positions may not fully match and thus require manual adjustments at either the clearing member or the client. Partial payments are made to fulfil obligations by each party further adding complexity to reconciliations.

Clients: Net payments to and from multiple clients need to be reconciled.

Regulators:

1—Regulators such as the CFTC (Commodity Futures Trading Commission), SEC (Securities and Exchange Commission), ESMA (European Securities and Markets Authority), CESR (Committee of European Securities Regulators), Federal Reserve, and the like require different regulatory reporting filings that tie in the payments to the different positions of the parties.

2—Regulators request the filings from multiple parties and then run checks to make sure that the records match.

In other examples, payments flow as part of a Forex (FX) workflow. Forex is a market for trading currencies. In an example Forex workflow where customer A enters into a Forex trade with customer B, the following reconciliations need to happen between the participants:

1—Customers A and B may choose to trade directly with the market maker or through their correspondent banks that have a relationship with a market maker.

2—The market maker creates the market and facilitates the trade by connecting the two parties: one that is buying currency “A” in return for one that is selling currency “B”. The market maker earns the spread between the buying price and selling price which may be higher than market price. Additionally, they may charge fees for the services.

3—If correspondent banks are involved, the market maker will need to wire the funds to the end accounts for customer A and customer B. This involves wiring funds through the central bank in the respective countries.

4—The market maker often has different ledger technologies in the two countries and they may also operate as different legal entities. Additionally, they may also have nostro accounts to reconcile the fund payments of obligations between the legal entities. A nostro account refers to an account at a bank that holds a foreign currency from another bank.

5—Additionally, there may be multiple reconciliations needed: between a customer and correspondent banks on both sides of a transaction; and between a correspondent bank and market makers on both sides of a transaction.

As discussed herein, the described systems and methods use a shared ledger (e.g., ledger 118 in FIG. 1) to maintain a history of all transactions within a network or other operating environment. The shared ledger provides a query interface for participants and observers to search for parts of the ledger they are authorized to view. Additionally, the ledger also has a subscription-based interface for the participants to be notified of changes in the network as they happen. The following are important components of the ledger: transactions, transaction states, securing the ledger entries, querying and subscribing to the ledger, and replicating the ledger.

In some embodiments, transactions are initiated by the members for one-off money transfer requests or when a workflow is executed by the members of a clearing group. Execution of a workflow will trigger one or more transactions that reflect the movement of assets between the participants. Each transaction can include metadata that the principals can use for internal business processes. Metadata examples include reconciliation instructions or specific messages or accounting code that participants can agree upon. A transaction may have various states that it passes through from an initial state to a terminal state. It is easier to think of this as a state diagram.

As discussed herein, the described systems and methods facilitate the movement of assets between principals. In some embodiments, the participants are large financial institutions in capital markets that trade multiple financial products. Trades in capital markets can be complex and involve large asset movements (also referred to as “settlements”). The systems and methods described herein can integrate with financial institutions and central settlement authorities such as the US Federal Reserve, DTC, and the like to facilitate the final settlement of assets.

The described systems and methods also have the ability to execute workflows such as DVP, threshold-based settlement, or time-based settlement between participants. Via the workflows, the systems and methods settle transactions in gross or net amounts. The systems and methods can use settlement accounts to hold assets while a transaction is being executed.

The following discussion explains the account structures and methods that facilitate the asset movements and enable the creation of operating rules associated with settlement finalities, such as credits to the settlement accounts. The following also describes the rationale for special account status for the funds in settlement accounts and describes how the systems and methods support this rationale. Additionally, various operating rules are discussed that affect the execution of transactions, settlement of transactions, and the like.

In some embodiments, settlement accounts (also referred to as suspense accounts) are special purpose accounts. For example, settlement accounts may be protected from the risk of default of the institution at which these accounts are held or from the default of the originator of the assets that fund settlement accounts. The assets in the settlement accounts are specifically for counterparties as was specified in the settlement instruction. Once the assets move from the sellers account into the settlement account, they cannot be recalled by the seller. There is no unwinding of the transaction that led to the funds going into the settlement account. In some embodiments, the settlement accounts may be multi-currency and/or multi-asset accounts.

As discussed herein, the described systems and methods may include a clearing and settlement gateway, shared permissioned ledger, and one or more workflows. The clearing and settlement gateway is used to integrate to the core ledgers of the banks and settlement agencies to initiate and execute clearing and settlement. When an asset is cleared or settled, it goes through several state changes. The shared permissioned ledger records the state changes and makes that information available to the permissioned parties in real time (or substantially real time).

Parties in a trade can execute complex settlement instructions that determine the sequence of steps that must be followed to effect the movement of assets between participants. The systems and methods described herein facilitate this with software workflows. Execution of a workflow will result in multiple instructions that are sent and received through the clearing and settlement gateway and multiple records in the shared permissioned ledger.

In some embodiments, the parties of a trade can be categorized as principals, observers, settlement agents or regulatory bodies. Principals are typically the buyers and sellers in a transaction. For bilateral trades, this usually includes the broker-dealers and buy-side clients. For cleared trades this may also include a CCP. Observers include all intermediaries in a trade that are involved in the asset movement between the buyers and sellers, and are involved in the trade life cycle. Examples of observers are settlement banks, custodian banks, NCSD, and the like. In some embodiments, the observers may extend credits or guarantee funds to the principals to complete a settlement.

Settlement agents include technology companies that facilitate the post trade settlement of the trade. In some embodiments, there is more than one settlement agent for a trade. Settlement agents typically act on the instructions of the principals or observers. They can also provide data reports to all the participants. The participants and observers of a trade may have different regulatory reporting requirements associated with one or more regulatory bodies. The type of reports depend on, for example, the trade type, asset type, and jurisdiction.

Workflows, Clearing, and Settlement

The settlement of assets between participants can involve complex workflows from the point that the settlement instructions are created to the time when the assets are actually credited and debited from the accounts. The sequence of actions for enabling a settlement can also differ depending on the workflow and type of assets. Some commonly used settlement sequences include DVP, PVP, FOP (Free of Payments), simple one way payments, and payments to and from segregated client accounts.

The systems and methods described herein can be used to build and execute complex workflows. Execution of the workflows results in assets being cleared and settled as agreed upon by participants. In capital markets, participants agree on a set of operating rules which also include specific rules on settlement finality. The rules can be different depending on the trade type, asset types or jurisdiction. In some cases, the rules are set by a central counterparty (CCP) or regulatory bodies. Some examples of the operating rules are discussed in the CME US Rule Book, ICE US Rule Book, ICE European Rule Book, and the Board of the International Organization of Securities Commissions on margin requirements for bilateral trades. In some embodiments, movement of assets involves clearing and settlements across multiple banks.

In some embodiments, clearing is defined as the intra-bank movement of assets. More specifically, clearing may involve the following steps:

1. Integrating into the core ledgers and payment gateway of the institutions that are involved in the asset movement.

2. Issuing and receiving a series of messages to determine the balance, initiating requests for debits and credits, and getting confirmations of debits and credits.

In some embodiments, the above steps support multiple assets classes.

Settlement is defined as the inter-bank movement of assets in a manner that is final and irreversible. This may involve, for example, the following steps:

1. Integrating into the payment gateway of the banks to issue settlement instruction to the appropriate central settlement agency (e.g., US Fed or DTC in the US) to move the assets between two accounts that reside at the settlement agency.

2. Alternately, the systems and methods described herein may have a direct connection to the central settlement agencies in some jurisdictions. In that situation, the participants can grant the systems and methods described herein a power of attorney to issue settlement instructions on behalf of the parties to perform the same settlement.

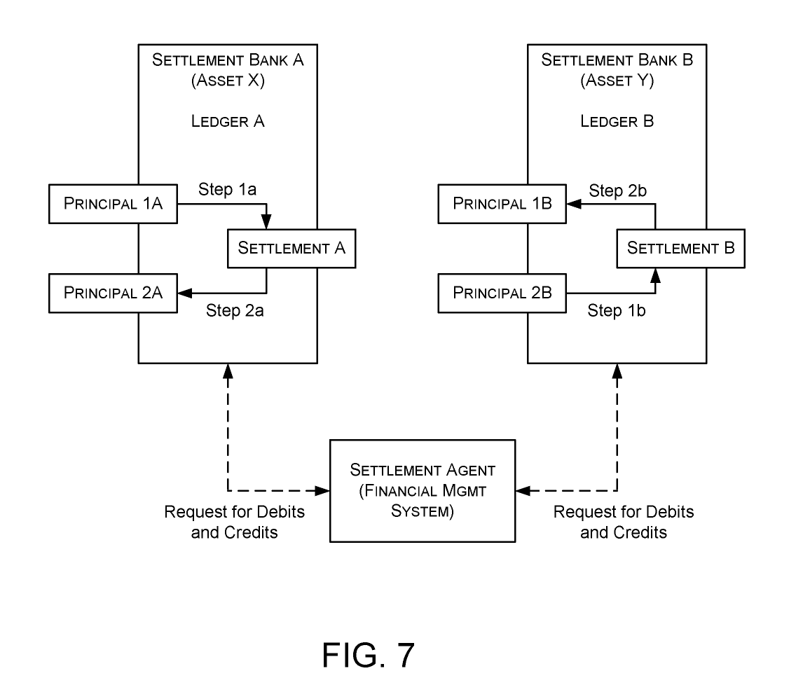

FIG. 7 illustrates an embodiment of an example bilateral asset transfer between two principals (e.g., Principal 1 and Principal 2). In this example, Principal 1A buys asset Y and sells asset X. Principal 2B buys asset X and sells asset Y. The systems and methods described herein act as the settlement agent for this bilateral asset transfer. The described systems and methods may use settlement accounts (also referred to as suspense accounts) at Settlement Bank A and Settlement Bank B. In this example, both Principal 1 and Principal 2 have nostro accounts to hold the assets of each type. A nostro accounts may include an account at a bank that holds funds in a foreign currency in another bank.

In the example of FIG. 7, settlement account A and settlement account B hold cleared funds for the benefit of a counterparty. Principal 1A is a source account for asset X (to be sold by Principal 1) and Principal 1B is a destination account for asset Y (to be sold by Principal 2 and purchased by Principal 1). This is also referred to as the nostro account for Principal 1 at Settlement Bank B.

Similarly, Principal 2A is a destination account for asset X (sold by Principal 1 and purchased by Principal 2). This is also referred to as the nostro account for principal 2 at Settlement Bank A. Principal 2B is the source account for asset Y (sold by Principal 2 and purchased by Principal 1).

In some embodiments, the accounts discussed with respect to FIG. 7 are located at different financial institutions. The systems and methods described herein can operate with accounts held at any financial institution. For example, if asset X and Y are separate currencies (USD and GBP) then Settlement accounts that hold the USD and GBP will likely be in separate jurisdictions. In some embodiments, the existing account structures in place at the financial institutions will not need any changing. The only change at the financial institutions is the creation of a new type of an account called the settlement account (or suspense account).

The systems and methods described herein issue clearing and settlement instructions to the settlement banks for each step that involves asset movement (e.g., steps 1a, 1b, 2a, and 2b). In the case of a debit, debit the account Principal 1A is debited asset X (number of units specified in the settlement instructions which are input as parameters to the workflow) and credited to Settlement Account A. Account Principal 2B is then debited asset Y and credited to Settlement Account B. Once the conformations of both debits are received, the system proceeds to a credit, credit where Settlement Account B is debited asset Y and Principal 1B is credited asset Y. Additionally, Settlement Account A is debited asset X and Principal 2A is credited asset X.

If there is a failure in the debit, debit transactions, the described systems and methods will retry the failed leg as defined in the operating rules (e.g., the operating rules may define X times to retry or define a time-based threshold). If the transaction does not succeed, it will reverse the debits and credits to restore the original amounts in account Principal 1A and account Principal 2B.

Recording Final Obligations

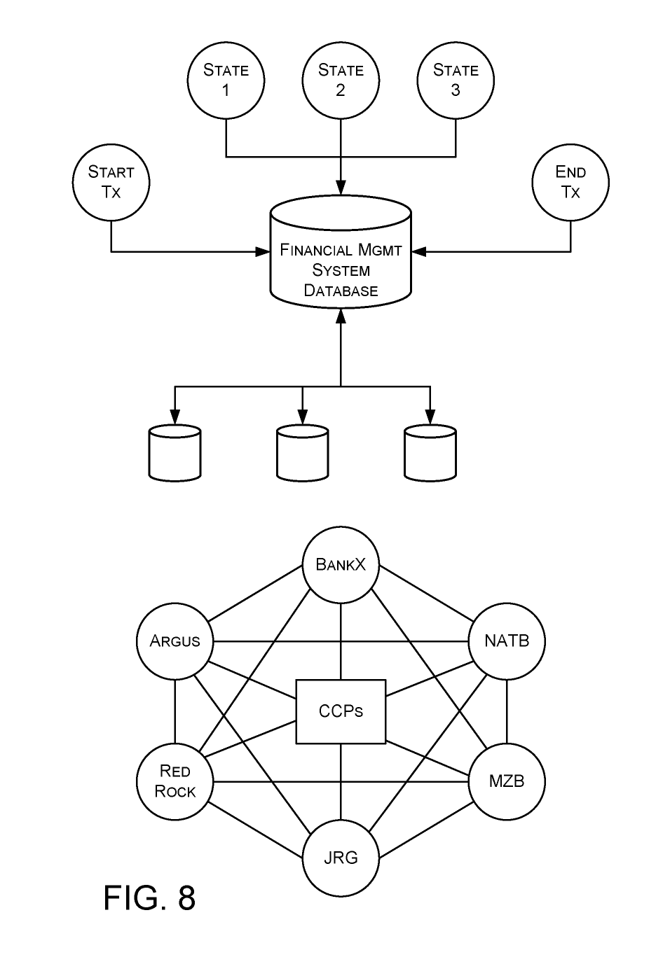

The described systems and methods maintain a shared permissioned ledger. The transactions are recorded such that the principals of the transaction only have access to the data that pertains to their side of the transaction. When the product is a cleared product (i.e., it has a CCP) both sides of the transaction are available to the CCP, but all of the allocation data is not available. The described systems and methods maintain both sides of the transaction as illustrated in FIG. 8.

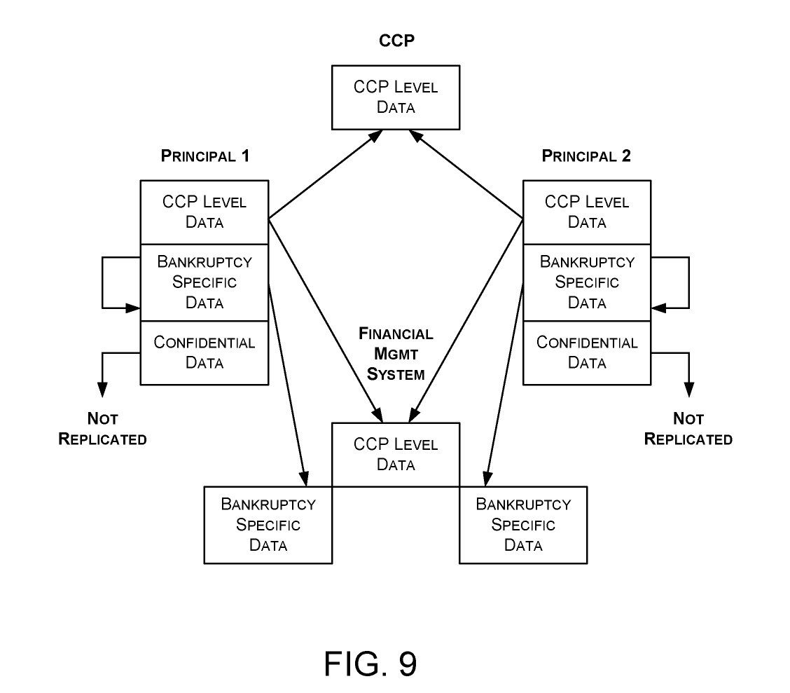

FIG. 9 illustrates an embodiment of various levels of data protection provided by the systems and methods described herein. For example, the bankruptcy specific data is the obligation of each principal (from the assets in its settlement accounts) to its counterparties. This data is not shared with the CCP. This data is however shared with the systems and methods described herein. For example, it is possible that this is “calculated” in real time (or substantially real time) by the systems and methods discussed herein. If Principal 1 is declared insolvent, then, since the assets are ring-fenced in settlement accounts, counterparties can rest assured that the assets will be “settled.” In this situation, settlement can mean one of the following:

1. Transferred to the rightful owner (as determined by the bankruptcy specific data) but reside in the same institution that held the settlement account. The underlying assumption here is that the settlement account was held at an institution that was not affected by the bankruptcy of Principal 1. In this situation, the described systems and methods will have the requisite information in its ledger and can, upon confirmation of the bankruptcy administrator, move the assets to Principal 2.

2. Moved out of the existing settlement account and institution to a different custodian or settlement bank. In this situation, if the new custodian or settlement bank is a member of the systems and methods described herein, the systems and methods can, upon notification from the bankruptcy administrator, move the assets. Alternatively, the assets can be moved by the bankruptcy administrator and the action recorded on the shared permissioned ledger. Since the shared permissioned ledger is replicated to Principal 2, the same existing systems will get data as they would if this event had occurred in a non-bankruptcy scenario.

Bankruptcy scenarios can be difficult situations from multiple different perspectives—reputational, financial stability of the overall ecosystem, and trust. The transparency afforded by the shared permissioned ledger will ensure that:

1. Defaulted institutions transfer assets to their rightful owners of the assets and thereby control reputational risk for the ecosystem.

2. Asset owners prevent a “run” on them as they never lose control or visibility of the assets.

3. The overall ecosystem is able to control the damage stemming from a failed institution.

The systems and methods described herein also include reporting capabilities that follow established norms and standards by the appropriate jurisdiction. In some embodiments, principals in a transaction can be from different jurisdictions that may interpret failure scenarios differently and will have different procedures to manage bank failures. For example, if a specific jurisdiction allows leverage that exceeds United States norms, then leverage in the system outside the United States can be made available to United States regulators. Although the United States regulators may not be able to curtail the leveraging, they will, at a minimum, be aware of the situation.

In some embodiments, the data in the systems and methods described herein is considered to be accurate and the data store (or database) is immutable. On top of this immutable data store is a platform that is built using state of the art, flexible technology components. As a result, the described systems and methods can provide visibility that a particular regulator seeks in a particular jurisdiction. Additionally, regulators may be nodes connected to the described systems and methods. If a particular bankruptcy situation falls under the purview of a regulator that was not included when the systems and methods were set up, the systems and methods can quickly provision a node for exclusive use of the particular regulator. This way, regulators can “share” data on bankruptcy scenarios. This data will follow the same accuracy and immutability as discussed above.

As discussed herein, the described systems and methods may use a tiered architecture that can scale up to requests for clearing and settlement. This architecture provides for an automatically scaled architecture where specific services, such as clearing services, can scale up or shrink depending on the requests.

As discussed herein, the shared permissioned ledger maintains a history of all transactions within the network. The shared permissioned ledger provides a query interface for participants to search for parts of the ledger. Additionally, it also has a subscription-based interface to the participants to subscribe to changes in the network in real time (or substantially real time). In some embodiments, components of the shared permissioned ledger include transaction states, securing the ledger entries, querying and subscribing to the ledger, and ledger replication.

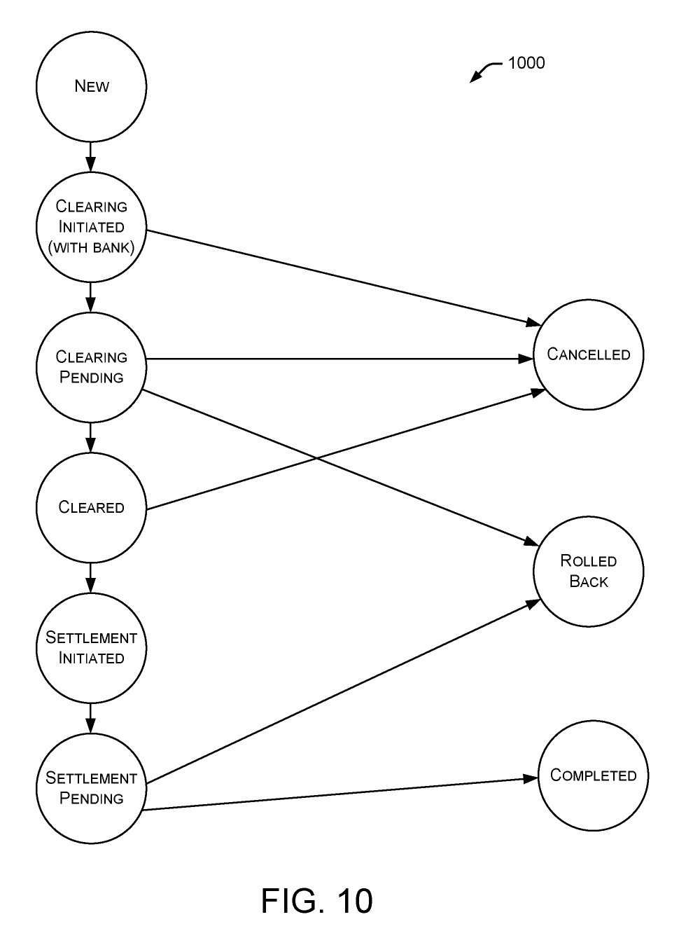

The systems and methods described herein may initiate transactions at the request of a participant or when a trigger-based clearing or settlement is set by the participants. A transaction has various states that it passes through from the initial state to the terminal state. FIG. 10 illustrates a state diagram of the various states.

The transactions and the associated states have additional metadata. The shared permissioned ledger records all of the state changes for a particular transaction. For each transaction, multiple records are stored to show the state changes. In some embodiments, the record is never updated. By default, all transactions are final and irreversible. However, some transactions may have been created in error (e.g., “fat finger”). For such transaction to be reversed, a new transaction is initiated. The metadata for the new transaction includes a reference to the transaction that needs to be reversed. The parties are informed on the request to reverse the transaction as part of a new transaction. The new transaction also goes through the state changes shown in FIG. 10. When completed, the metadata of the initial transaction is also updated (making that mutable just for this scenario).

FIG. 10 illustrates an example state diagram 1000 showing various states that a transaction may pass through. As shown in FIG. 10, a particular transaction may be initiated (“new”), then clearing is initiated with a bank, after which the transaction's state is “clearing pending.” The next transaction state is “cleared”, then settlement is initiated, after which the transaction state is “settlement pending.” After the transaction has settled, the state becomes “completed.” As shown in state diagram 1000, the state diagram may branch to “cancelled” at locations in the state diagram. For example, a transaction may be cancelled due to insufficient funds, a mutual decision to reverse the transaction before settlement, a bank internal ledger failure, and the like. Additionally, the state diagram may branch to “rolled back” at multiple locations. For example, a transaction may be rolled back due to an unrecoverable error, a cancellation of the transaction, and the like.

Each transaction and the associated transaction states may have additional metadata. The shared ledger (e.g., ledger 118 in FIG. 1) man contain all the state information and state changes for a transaction. A separate record is maintained for each state of the transaction. The record is not updated or modified. In some embodiments, all transactions are final and irreversible. The metadata for the new transaction includes a reference to the erroneous transaction that needs to be reversed. The parties are informed of the request to reverse the erroneous transaction as part of a new transaction. The new transaction also goes through the state changes shown in FIG. 10. When the new transaction is completed, the metadata of the initial transaction is also updated.

In some embodiments, the transactions and the metadata recorded in the shared permissioned ledger contain information that are very sensitive and confidential to the businesses initiating the instructions. The systems and methods described herein maintain the security of this information by encrypting data for each participant using a symmetric key that is unique to the participant. In some embodiments, the keys also have a key rotation policy where the data for that node is rekeyed. The keys for each node are bifurcated and saved in a secure storage location with role-based access controls. In some embodiments, only a special service called a cryptographic service can access these keys at runtime to encrypt and decrypt the data.

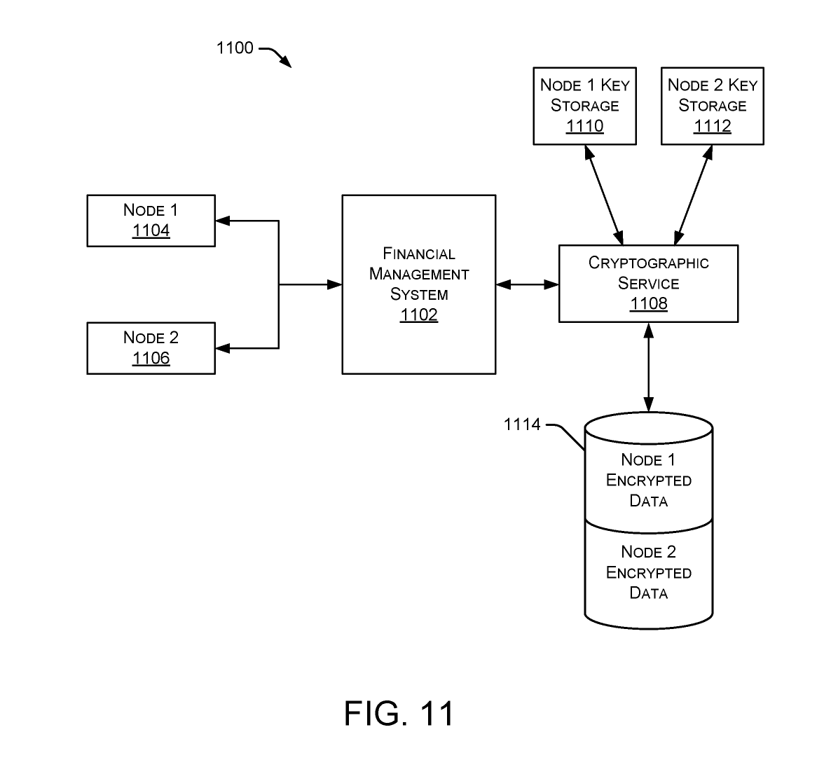

FIG. 11 is a block diagram illustrating an embodiment 1100 of a financial management system 1102 interacting with a cryptographic service 1108 and multiple client nodes 1104 and 1106. Although two client nodes 1104, 1106 are shown in FIG. 11, alternate embodiments may include any number of client nodes coupled to financial management system 1102. In the embodiment of FIG. 11, financial management system 1102 communicates with client nodes 1104, 1106 to manage one or more transactions between client nodes 1104 and 1106, or between one of client nodes 1104, 1106 and other client nodes, devices, or systems (not shown). Financial management system 1102 also communicates with cryptographic service 1108, which manages secure access to a data store 1114. In some embodiments, data store 1114 is a shared ledger (e.g., ledger 118 in FIG. 1) of the type discussed herein. In these embodiments, data store 1114 represents the capabilities of the shared ledger as they relate to data permissions.

As shown in FIG. 11, data store 1114 stores encrypted data associated with client nodes 1104 and 1106. In alternate embodiments, data store 1114 may store encrypted data associated with any number of client nodes. Cryptographic service 1108 ensures security of the data in data store 1114 using, for example, secure bifurcated keys that are stored in node 1 key storage 1110 and node 2 key storage 1112. Each key is unique for the associated client node. When financial management system 1102 wants to access data from data store 1114, the data access request must include an appropriate key to ensure that the data access request is authorized.

Each transaction can have two or more participants. In addition to the multiple parties involved in the transaction, there can be one or more “observers” to the transaction. The observer status is important from a compliance and governance standpoint. For example, the Federal Reserve or the CFTC is not a participant of the transaction, but may have observer rights on certain type of transactions in the system. In some embodiments the participants can subscribe to certain types of events. The transaction state in the state diagram above changes trigger events in the described systems.

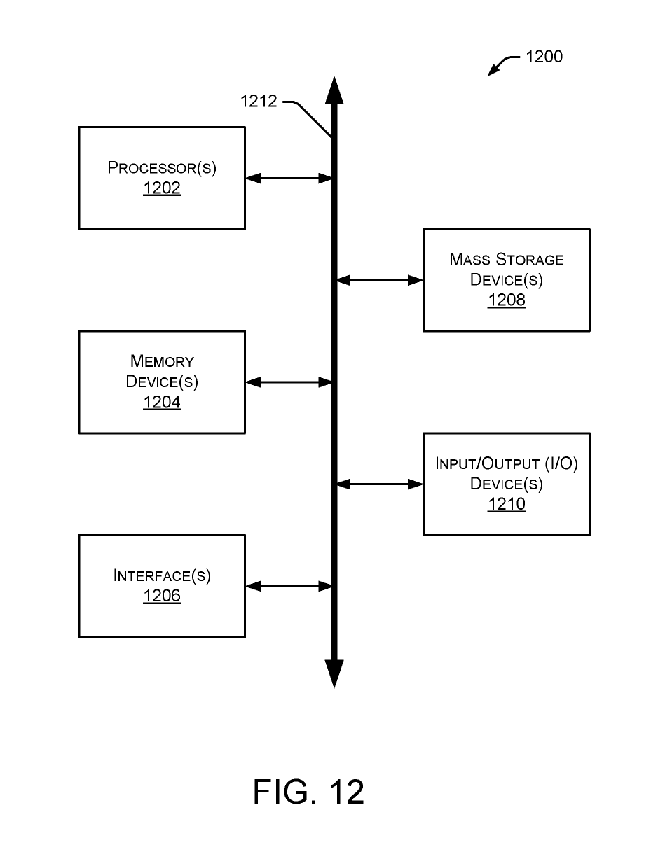

FIG. 12 is a block diagram illustrating an example computing device 1200. Computing device 1200 may be used to perform various procedures, such as those discussed herein. Computing device 1200 can function as a server, a client, a client node, a financial management system, or any other computing entity. Computing device 1200 can be any of a wide variety of computing devices, such as a workstation, a desktop computer, a notebook computer, a server computer, a handheld computer, a tablet, a smartphone, and the like. In some embodiments, computing device 1200 represents any of the computing devices discussed herein.

Computing device 1200 includes one or more processor(s) 1202, one or more memory device(s) 1204, one or more interface(s) 1206, one or more mass storage device(s) 1208, and one or more Input/Output (I/O) device(s) 1210, all of which are coupled to a bus 1212. Processor(s) 1202 include one or more processors or controllers that execute instructions stored in memory device(s) 1204 and/or mass storage device(s) 1208. Processor(s) 1202 may also include various types of computer-readable media, such as cache memory.

Memory device(s) 1204 include various computer-readable media, such as volatile memory (e.g., random access memory (RAM)) and/or nonvolatile memory (e.g., read-only memory (ROM)). Memory device(s) 1204 may also include rewritable ROM, such as Flash memory.

Mass storage device(s) 1208 include various computer readable media, such as magnetic tapes, magnetic disks, optical disks, solid state memory (e.g., Flash memory), and so forth. Various drives may also be included in mass storage device(s) 1208 to enable reading from and/or writing to the various computer readable media. Mass storage device(s) 1208 include removable media and/or non-removable media.

I/O device(s) 1210 include various devices that allow data and/or other information to be input to or retrieved from computing device 1200. Example I/O device(s) 1210 include cursor control devices, keyboards, keypads, microphones, monitors or other display devices, speakers, printers, network interface cards, modems, lenses, CCDs or other image capture devices, and the like.

Interface(s) 1206 include various interfaces that allow computing device 1200 to interact with other systems, devices, or computing environments. Example interface(s) 1206 include any number of different network interfaces, such as interfaces to local area networks (LANs), wide area networks (WANs), wireless networks, and the Internet.

Bus 1212 allows processor(s) 1202, memory device(s) 1204, interface(s) 1206, mass storage device(s) 1208, and I/O device(s) 1210 to communicate with one another, as well as other devices or components coupled to bus 1212. Bus 1212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1200, and are executed by processor(s) 1202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” “selected embodiments,” “certain embodiments,” etc., indicate that the embodiment or embodiments described may include a particular feature, structure, or characteristic, but every embodiment may not necessarily include the particular feature, structure, or characteristic. Additionally, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that may be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can include at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired and wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions include, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a module may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method comprising:
identifying, by a financial management system, first operating rules associated with a first participant to a transaction;
identifying, by the financial management system, second operating rules associated with a second participant to the transaction;
creating, by the financial management system, a workflow that defines a sequence of activities associated with the transaction, wherein the workflow is created based on the first operating rules and the second operating rules; and
executing, by the financial management system, the workflow to implement the transaction.

2. The method of claim 1, wherein the first operating rules include specific rules associated with settlement of transactions.

3. The method of claim 1, wherein the first participant is a first financial institution and the second participant is a second financial institution.

4. The method of claim 3, wherein the transaction is an asset transfer between the first financial institution and the second financial institution.

5. The method of claim 1, wherein the first operating rules include at least one rule associated with transaction time limits.

6. The method of claim 1, wherein the first operating rules include at least one rule associated with limits on transaction amounts for at least one type of transaction.

7. The method of claim 1, wherein the first operating rules include a plurality of rules such that each of the plurality of rules is associated with a different financial institution.

8. The method of claim 1, further comprising:
identifying, by the financial management system, a first jurisdiction associated with the first participant to the transaction; and
identifying, by the financial management system, a second jurisdiction associated with the second participant to the transaction, wherein the workflow is further created based on rules associated with the first jurisdiction and rules associated with the second jurisdiction.

9. The method of claim 8, wherein the first jurisdiction and the second jurisdiction are different countries.

10. The method of claim 1, further comprising identifying, by the financial management system, third operating rules associated with the first participant to the transaction, wherein the workflow is created based on the first operating rules, the second operating rules, and the third operating rules.

11. The method of claim 10, wherein the first operating rules are associated with rules of the first participant to the transaction and the third operating rules are associated with rules of a jurisdiction in which the first participant is located.

12. The method of claim 10, wherein the first operating rules are associated with rules of the first participant to the transaction and the third operating rules are associated with rules of a jurisdiction in which the first participant is located.

13. The method of claim 10, wherein the first operating rules are associated with rules of the first participant to the transaction and the third operating rules are associated with rules of a regulatory organization overseeing the transaction.

14. An apparatus comprising:
a shared ledger configured to store data associated with a plurality of transactions; and
a financial management system coupled to the shared ledger, wherein the financial management system is configured to:
identify first operating rules associated with a first participant to a transaction;
identify second operating rules associated with a second participant to the transaction;
create a workflow that defines a sequence of activities associated with the transaction, wherein the workflow is created based on the first operating rules and the second operating rules; and
execute the workflow to implement the transaction.

15. The apparatus of claim 14, wherein the first operating rules include specific rules associated with settlement of transactions.

16. The apparatus of claim 14, wherein the first participant is a first financial institution, the second participant is a second financial institution, and the transaction is an asset transfer between the first financial institution and the second financial institution.

17. The apparatus of claim 14, wherein the first operating rules include a rule associated with at least one of transaction time limits and limits on transaction amounts for a particular type of transaction.

18. The apparatus of claim 14, wherein the financial management system is further configured to:
identify a first jurisdiction associated with the first participant to the transaction; and
identify a second jurisdiction associated with the second participant to the transaction, wherein the workflow is further created based on rules associated with the first jurisdiction and rules associated with the second jurisdiction.

19. The apparatus of claim 18, wherein the first jurisdiction and the second jurisdiction are different countries.

20. The apparatus of claim 14, wherein the financial management system is further configured to identify third operating rules associated with the first participant to the transaction, and wherein the workflow is created based on the first operating rules, the second operating rules, and the third operating rules.
